(19) United States
(12) Patent Application Publication
(10) Pub. No.: US 2022/0012357 A1
(43) Pub. Date: Jan. 13, 2022

(54) INTELLIGENT PRIVACY AND SECURITY ENFORCEMENT TOOL FOR UNSTRUCTURED DATA

(71) Applicant: BANK OF AMERICA CORPORATION, Charlotte, NC (US)

(72) Inventor: Harikrishnan Rajeev, Trivandrum (IN)

(73) Assignee: BANK OF AMERICA CORPORATION, Charlotte, NC (US)

(21) Appl. No.: 16/925,796

(22) Filed: Jul. 10, 2020

(51) Int. Cl. G06F 21/62; G06N 20/00; G06F 16/11

(52) U.S. Cl. CPC G06F 21/6245; G06F 16/116; G06N 20/00

(57) ABSTRACT

Embodiments of the present invention provide systems and methods for intelligent privacy and security enforcement of unstructured data. The system may receive a data submission from a user device over one or more communication channels and convert the data submission into a normalized text format for processing and analysis. The data submission may then be analyzed using one or more trained machined learning models in order to identify sensitive information within the data submission, and automate the process of masking the sensitive data with generic mask data.

### FIELD OF THE INVENTION

The present invention is generally related to systems and methods for providing an enhanced automated system for protection of sensitive data.

### BACKGROUND

There is a need for an intelligent, proactive and responsive system that facilitates the identification, regulation and safeguarding of sensitive data elements, particularly when those elements are part of an unstructured data source. Current technologies that incorporate data masking techniques are largely manual or rule-based, and are prone to errors and require frequent maintenance and review. This poses a problem for organizations that desire or are required to safeguard large amount of unstructured data, both in terms of security level and cost.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later. Embodiments of the present invention address present needs by providing a system for intelligent privacy and security enforcement for regulation of unstructured data by providing a solution for an intelligent, knowledge augmented security enforcement tool for masking data. The solution comprises the use of an intelligent self-learning artificial intelligence (AI) model for masking unstructured production data. Usual techniques are simply rule driven or keyword driven, while the proposed solution incorporates the use of AI learning techniques to recognize sensitive data types un an unsupervised fashion. The model of the solution possesses the functionality to learn the ability to identify and categorize sensitive data, and may extrapolate learning techniques from a training data set in order to identify new sensitive data outside the proposed training data set metrics. As such, the solution does not require the creation or maintenance of rule-based scripts, and alleviates operational difficulties, reduces cost, and increases reliability versus existing solutions.

In some instances, the system comprises: at least one memory device with computer-readable program code stored thereon, at least one communication device, at least one processing device operatively coupled to the at least one memory device and the at least one communication device, wherein executing the computer-readable program code is typically configured to cause the at least one processing device to perform, execute or implement one or more features or steps of the invention. Embodiments of the invention relate to systems, computer implemented methods, and computer program products for security enforcement and regulation of unstructured data, the system comprising: at least one memory device with computer-readable program code stored thereon; at least one communication device; at least one processing device operatively coupled to the at least one memory device and the at least one communication device, wherein executing the computer-readable program code is configured to cause the at least one processing device to: receive, from one or more data channels and data sources, data files comprising unmasked data; extract text data from the unmasked data; parse the text data and analyze syntax of the text data via a machine learning engine; identify and categorize sensitive text data via the machine learning engine, wherein the sensitive text data is a subset of the text data; replace the sensitive text data with generic mask data to generate masked text data; compile the masked text data and reconstruct the data files by substituting the unmasked data with masked data; and store the data file as a secure masked data file.

In some embodiments, extracting text data from the unmasked data further comprises converting the data files from an originating file type to plain text data.

In some embodiments, the machine learning engine further comprises an unsupervised machine learning model, wherein the unsupervised machine learning model detects sensitive text data based on contextual syntax of the text data.

In some embodiments, the machine learning engine further comprises an unsupervised machine learning model operatively connected to a knowledge database of exemplary sensitive text data types.

In some embodiments, the generic mask data further comprises a black rectangular shape character in place of an alphanumeric character.

In some embodiments, reconstructing the data files further comprises converting plain text data containing masked data to an originating file type of the data files.

In some embodiments, the machine learning engine further comprises an unsupervised machine learning model trained to identify one or more rules for contextual analysis of the text data without human supervision.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 depicts a system environment 100 providing a system for privacy and security enforcement, in accordance with one embodiment of the present invention;

FIG. 2 provides a block diagram of the user device 104, in accordance with one embodiment of the present invention;

FIG. 3 depicts a high level process flow for the processing of unstructured data, in accordance with embodiments of the present invention;

FIG. 4 depicts an example of an unmasked document 51, in accordance with embodiments of the present invention;

FIG. 5 depicts an example of a masked document 52, in accordance with embodiments of the present invention; and

FIG. 6 depicts a high level process flow of intelligent data masking, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

In some embodiments, an “entity” or “enterprise” as used herein may be any institution or establishment, associated with a network connected resource transfer platform, and particularly geolocation systems and devices. As such, the entity may be any institution, group, association, financial institution, merchant, establishment, company, union, authority or the like. In other embodiments, “entity” may refer to a data element, character string, word, phrase, or the like identified in a data file or string of text. A “sensitive entity” may refer to a subset of data elements that warrant redaction, enhanced security, removal, or masking from an electronic document. As used herein, a “third party” or “third party system” may be an entity that does not manage the data verification system, but provides data to or receives data from the data verification system or entity system that controls the data verification system. It is understood that one or more third party systems and entities are contemplated as communicating with the data verification system over a network.

As described herein, a “user” is an individual associated with an entity or institution. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

In the instances where the entity is a resource entity or a merchant, financial institution or the like, a user may be an individual or entity with one or more relationships, affiliations or accounts with the entity (for example, the merchant, the financial institution). In some embodiments, the user may be an entity or financial institution employee (e.g., an underwriter, a project manager, an IT specialist, a manager, an administrator, an internal operations analyst, bank teller or the like) capable of operating the system described herein. In some embodiments, a user may be any individual or entity who has a relationship with a customer of the entity or financial institution. For purposes of this invention, the term “user” and “customer” may be used interchangeably.

An “account” may be established by the relationship that the user has with the entity. Examples of accounts include a deposit account, such as a transactional account (e.g. a banking account), a savings account, an investment account, a money market account, a time deposit, a demand deposit, a pre-paid account, a credit account, a non-monetary user configuration that includes personal information associated with the user, or the like. The account may typically be associated with and/or maintained by an entity, or associated with technology infrastructure such that the account or resources stored in the account may be accessed, modified or acted upon by the user electronically, for example using or transaction terminals, user devices, merchant systems, or the like. In some embodiments, the entity may provide one or more technology instruments or financial instruments to the user for executing resource transfer activities or financial transactions. In some embodiments, the technology instruments/financial instruments like electronic tokens, credit cards, debit cards, checks, loyalty cards, entity user device applications, account identifiers, routing numbers, passcodes or the like are associated with one or more resources or accounts of the user. In some embodiments, an entity may be any institution, group, association, club, establishment, company, union, authority or the like with which a user may have a relationship. As discussed, in some embodiments, the entity represents a vendor or a merchant with whom the user engages in financial (for example, resource transfers like purchases, payments, returns, enrolling in merchant accounts or the like) or non-financial transactions (for resource transfers associated with loyalty programs or the like), either online or in physical stores.

As used herein, a “user interface” may be a graphical user interface that facilitates communication using one or more communication mediums such as tactile communication (such, as communication via a touch screen, keyboard, or the like), audio communication, textual communication and/or video communication (such as, gestures). Typically, a graphical user interface (GUI) of the present invention is a type of interface that allows users to interact with electronic elements/devices such as graphical icons and visual indicators such as secondary notation, as opposed to using only text via the command line. That said, the graphical user interfaces are typically configured for audio, visual and/or textual communication, and are configured to receive input and/or provide output using one or more user device components and/or external auxiliary/peripheral devices such as a display, a speaker, a microphone, a touch screen, a camera, a GPS device, a keypad, a mouse, and/or the like. In some embodiments, the graphical user interface may include both graphical elements and text elements. The graphical user interface is configured to be presented on one or more display devices associated with user devices, entity systems, auxiliary user devices, processing systems or the like.

An electronic activity, also referred to as a “technology activity” or a “user activity”, such as a “resource transfer” or “transaction”, may refer to any activities or communication between a user or entity and the financial institution, between the user and the entity, activities or communication between multiple entities, communication between technology applications or the like. A resource transfer may refer to a payment, processing of funds, purchase of goods or services, a return of goods or services, a payment transaction, a credit transaction, or other interactions involving a user's resource or account. In the context of a financial institution or a resource entity such as a merchant, a resource transfer may refer to one or more of: transfer of resources/funds between financial accounts (also referred to as “resources”), deposit of resources/funds into a financial account or resource (for example, depositing a check), withdrawal of resources or finds from a financial account, a sale of goods and/or services, initiating an automated teller machine (ATM) or online banking session, an account balance inquiry, a rewards transfer, opening a bank application on a user's computer or mobile device, a user accessing their e-wallet, applying one or more resources to purchases, or any other interaction involving the user and/or the user's device that invokes or that is detectable by or associated with the financial institution. A resource transfer may also include one or more of the following: renting, selling, and/or leasing goods and/or services (e.g., groceries, stamps, tickets, DVDs, vending machine items, or the like); making payments to creditors (e.g., paying monthly bills; paying federal, state, and/or local taxes; or the like); sending remittances; loading money onto stored value cards (SVCs) and/or prepaid cards; donating to charities; and/or the like. Unless specifically limited by the context, a “resource transfer,” a “transaction,” a “transaction event,” or a “point of transaction event,” refers to any user activity (financial or non-financial activity) initiated between a user and a resource entity (such as a merchant), between the user and the financial instruction, or any combination thereof.

In some embodiments, a resource transfer or transaction may refer to financial transactions involving direct or indirect movement of funds through traditional paper transaction processing systems (i.e. paper check processing) or through electronic transaction processing systems. In this regard, resource transfers or transactions may refer to the user initiating a funds/resource transfer between account, funds/resource transfer as a payment for the purchase for a product, service, or the like from a merchant, or the like. Typical financial transactions or resource transfers include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures, or the like.

In accordance with embodiments of the invention, the term “user” may refer to a merchant or the like, who utilizes an external apparatus such as a user device, for retrieving information related to the user's business that the entity may maintain or compile. Such information related to the user's business may be related to resource transfers or transactions that other users have completed using the entity systems. The external apparatus may be a user device (computing devices, mobile devices, smartphones, wearable devices, or the like). In some embodiments, the user may seek to perform one or more user activities using a multi-channel cognitive resource application of the invention, or user application, which is stored on a user device. In some embodiments, the user may perform a query by initiating a request for information from the entity using the user device to interface with the system for adjustment of resource allocation based on multi-channel inputs in order to obtain information relevant to the user's business.

In accordance with embodiments of the invention, the term “unstructured data” or “unstructured information” is data that either does not have a pre-defined data model or is not organized in a pre-defined manner or according to pre-defined rules. Unstructured data is typically text-heavy, but may contain data such as dates, numbers, and facts as well. In some embodiments, unstructured data may include, but is not limited to, text files, scanned images of documents, payment instruments, contracts, form documents, applications, or the like.

In accordance with embodiments of the invention, the term “payment instrument” may refer to an electronic payment vehicle, such as an electronic credit or debit card. The payment instrument may be account identifying information stored electronically in a user device, such as payment credentials or tokens/aliases associated with a digital wallet, or account identifiers stored by a mobile application. In accordance with embodiments of the invention, the term “module” with respect to an apparatus may refer to a hardware component of the apparatus, a software component of the apparatus, or a component of the apparatus that comprises both hardware and software. In accordance with embodiments of the invention, the term “chip” may refer to an integrated circuit, a microprocessor, a system-on-a-chip, a microcontroller, or the like that may either be integrated into the external apparatus or may be inserted and removed from the external apparatus by a user.

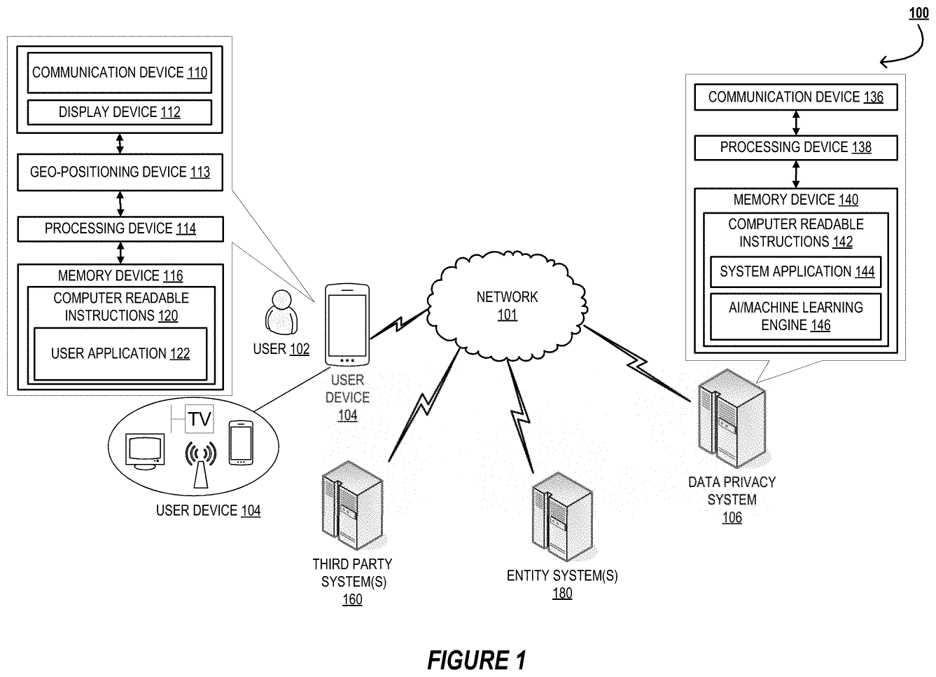

FIG. 1 depicts a system environment 100 providing a system for privacy and security enforcement, in accordance with one embodiment of the present invention. As illustrated in FIG. 1, a data privacy system 106, configured for providing an intelligent, proactive and responsive application or system, at a user device 104, which facilitates execution of electronic activities in an integrated manner, and which is capable of adapting to the user's natural communication and its various modes by allowing seamless switching between communication channels/mediums in real time or near real time. The data verification system is operatively coupled, via a network 101 to one or more user devices 104, to entity systems 180, third party systems 160, and other external systems/third-party servers not illustrated herein. In this way, the data privacy system 106 can send information to and receive information from multiple user devices 104 to provide an integrated platform with multi-channel data analysis capabilities to a user 102, and particularly to the user device 104. At least a portion of the system for enforcement of privacy and security of unstructured data records (or “system”) may be configured to reside on the user device 104 (for example, at the user application 122), on the data privacy system 106 (for example, at the system application 144), and/or on other devices and system. Furthermore, the system is capable of seamlessly adapting to and switching between unstructured data formats, and may be infinitely customizable by the system 106 and/or the user 102 to receive and analyze data records in any language.

The network 101 may be a global area network (GAN), such as the Internet, a wide area network (WAN), a local area network (LAN), or any other type of network or combination of networks. The network 101 may provide for wireline, wireless, or a combination wireline and wireless communication between devices on the network 101. The network 101 is configured to establish an operative connection between devices, for example establishing a communication channel, automatically and in real time, between the one or more user devices 104. In this regard, the network 101 may take the form of contactless interfaces, short range wireless transmission technology, such near-field communication (NFC) technology, Bluetooth® low energy (BLE) communication, audio frequency (AF) waves, wireless personal area network, radio-frequency (RF) technology, and/or other suitable communication channels.

In some embodiments, the user 102 is an individual that wishes to request or submit data from the data privacy system 106 using the user device 104. In some embodiments, the user 102 may access the data privacy system 106, and/or the entity system 180 through a user interface comprising a webpage or a user application. Hereinafter, “user application” is used to refer to an application on the user device 104 of the user 102, a widget, a webpage accessed through a browser, or the like. As such, in some instances, the user device may have multiple user applications stored/installed on the user device 104 and the memory device 116 in particular. In some embodiments, the user application is a user application 122, also referred to as a “user application” 122 herein, provided by and stored on the user device 104 by the data privacy system 106. In some embodiments the user application 122 may refer to a third party application or a user application stored on a cloud used to access the data privacy system 106 through the network 101, communicate with or receive and interpret signals from user device 104, or the like. In some embodiments, the user application is stored on the memory device 140 of the data privacy system 106, and the user interface is presented on a display device of the user device 104, while in other embodiments, the user application is stored on the user device 104.

The user 102 may subsequently navigate through the interface or initiate one or more user activities or resource transfers using a central user interface provided by the user application 122 of the user device 104. In some embodiments, the user 102 may be routed to a particular destination or entity location using the user device 104. In some embodiments the user may use the user device 104 to request and/or receives additional information from the data privacy system 106/the resource entity system 160 and/or perform authentication steps to validate the user and/or the user device. In some embodiments, an identifier for the user device may be use in determining appropriate queues, executing information queries, and other functions. In other embodiments, the user application 122 may interface with one or more separate applications stored on the user device 104 such that it can receive and send data between applications in order to provide the user 102 with information. For instance, the user 102 may utilize a web browsing application on the user device 104 to open a webpage in the user application 122.

FIG. 1 also illustrates the user device 104. The user device 104, herein referring to one or more user devices, wherein each device may generally comprise a communication device 110, a display device 112, a geo-positioning device 113, a processing device 114, and a memory device 116. Typically, the user device 104 is a computing system that allows a user 102 to interact with other systems to initiate system tools, or the like. The processing device 114 is operatively coupled to the communication device 110 and the memory device 116. The processing device 114 uses the communication device 110 to communicate with the network 101 and other devices on the network 101, such as, but not limited to the resource entity system 160, and the data privacy system 106. As such, the communication device 110 generally comprises a modem, server, or other device for communicating with other devices on the network 101. In some embodiments the network 101 comprises a network of distributed servers. In some embodiments, the processing device 114 may be further coupled to a display device 112, a geo-positioning device 113, and/or a transmitter/receiver device, not indicated in FIG. 1. The display device 112 may comprise a screen, a speaker, a vibrating device or other devices configured to provide information to the user. In some embodiments, the display device 112 provides a presentation of the central user interface of the integrated user application 122. The geo-positioning device 113 may comprise global positioning system (GPS) devices, triangulation devices, accelerometers, and other devices configured to determine the current geographic location of the user device 104 with respect to satellites, transmitter/beacon devices, telecommunication towers or the like. In some embodiments the user device 104 may include authentication devices like fingerprint scanners, heart-rate monitors, microphones or the like that are configured to receive bio-metric authentication credentials from the user.

The user device 104 comprises computer-readable instructions 120 stored in the memory device 116, which in one embodiment includes the computer-readable instructions 120 of the user application 122. In this way, users 102 may authenticate themselves, initiate data analysis, data requests, or the like, and interact with or receive and decode signals from the user devices 104, communicate with the data privacy system 106 to request or transmit information. The user device 104 may be, for example, a desktop personal computer, a mobile system, such as a cellular phone, smart phone, personal data assistant (PDA), laptop, wearable device, a smart TV, a smart speaker, a home automation hub, augmented/virtual reality devices, or the like. The computer readable instructions 120 such as computer readable/executable code of the user application 122, when executed by the processing device 114 are configured to cause the user device 104 and/or processing device 114 to perform one or more steps described in this disclosure, or to cause other systems/devices to perform one or more steps described herein.

As further illustrated in FIG. 1, the data privacy system 106 generally comprises a communication device 136, at least one processing device 138, and a memory device 140. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 138 is operatively coupled to the communication device 136 and the memory device 140. The processing device 138 uses the communication device 136 to communicate with the network 101 and other devices on the network 101, such as, but not limited to the resource entity systems 160, and/or the user device 104. As such, the communication device 136 generally comprises a modem, server, wireless transmitters or other devices for communicating with devices on the network 101. The memory device 140 typically comprises a non-transitory computer readable storage medium, comprising computer readable/executable instructions/code, such as the computer-readable instructions 142, as described below.

As further illustrated in FIG. 1, the data privacy system 106 comprises computer-readable instructions 142 or computer readable program code 142 stored in the memory device 140, which in one embodiment includes the computer-readable instructions 142 of a system application 144 (also referred to as a “system application” 144). The computer readable instructions 142, when executed by the processing device 138 are configured to cause the system 106/processing device 138 to perform one or more steps described in this disclosure to cause out systems/devices (such as the user device 104, the user application 122, or the like) to perform one or more steps described herein. Data privacy system 106 also includes artificial intelligence (AI) and machine learning engine 146. In some embodiments, the AI and machine learning engine 146 is used to analyze received data in order to identify complex patterns and intelligently improve the efficiency and capability of the data privacy system 106 to analyze received data and identify patterns. In some embodiments, the AI and machine learning engine 146 may include supervised learning techniques, unsupervised learning techniques, or a combination of multiple machine learning models that combine supervised and unsupervised learning techniques. In some embodiments, the machine learning engine may include an adversarial neural network that uses a process of encoding and decoding in order to adversarial train one or more machine learning models to identify relevant patterns in received data received from one or more channels of communication.

Also pictured in FIG. 1 are one or more third party systems 160, which are operatively connected to the data privacy system 106 via network 101 in order to transmit data associated with user activities, user authentication, user verification, resource actions, or the like. For instance, the capabilities of the data privacy system 106 may be leveraged in some embodiments by third party systems in order to authenticate user actions based on data provided by the third party systems 160, third party applications running on the user device 104, as analyzed and compared to data stored by the data privacy system 106, such as data stored at entity systems 180. In some embodiments, the multi-channel data processing capabilities may be provided as a service by the data privacy system 106 to the entity systems 180, third party systems 160, or additional systems and servers not pictured, through the use of an application programming interface (“API”) designed to simplify the communication protocol for client-side requests for data or services from the data privacy system 106. In this way, the capabilities offered by the present invention may be leveraged by multiple parties other than the those controlling the data privacy system 106 or entity systems 180.

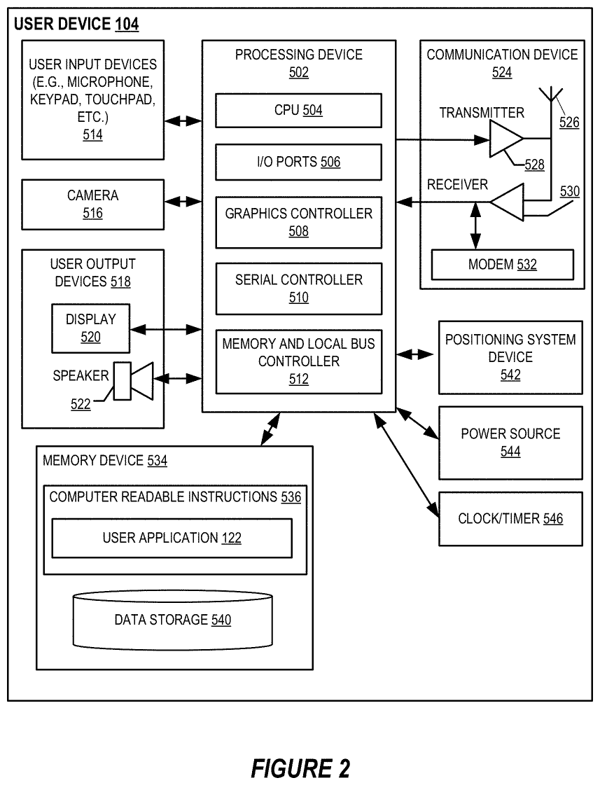

FIG. 2 provides a block diagram of the user device 104, in accordance with one embodiment of the invention. The user device 104 may generally include a processing device or processor 502 communicably coupled to devices such as, a memory device 534, user output devices 518 (for example, a user display device 520, or a speaker 522), user input devices 514 (such as a microphone, keypad, touchpad, touch screen, or the like), a communication device or network interface device 524, a power source 544, a clock or other timer 546, a visual capture device such as a camera 516, a positioning system device 542, such as a geo-positioning system device like a GPS device, an accelerometer, or the like. The processing device 502 may further include a central processing unit 504, input/output (I/O) port controllers 506, a graphics controller or graphics processing device (GPU) 208, a serial bus controller 510 and a memory and local bus controller 512.

The processing device 502 may include functionality to operate one or more software programs or applications, which may be stored in the memory device 534. For example, the processing device 502 may be capable of operating applications such as the user application 122. The user application 122 may then allow the user device 104 to transmit and receive data and instructions from the other devices and systems of the environment 100. The user device 104 comprises computer-readable instructions 536 and data storage 540 stored in the memory device 534, which in one embodiment includes the computer-readable instructions 536 of a user application 122. In some embodiments, the user application 122 allows a user 102 to access and/or interact with other systems such as the entity system 180, third party system 160, or data privacy system 106. In one embodiment, the user 102 is a maintaining entity of a data privacy system 106, wherein the user application enables the user 102 to define policies and reconfigure the data privacy system 106 or its components. In one embodiment, the user 102 is a customer of a financial entity and the user application 122 is an online banking application providing access to the entity system 180 wherein the user may interact with a resource account via a user interface of the user application 122, wherein the user interactions may be provided in a data stream as an input via multiple channels. In some embodiments, the user 102 may a customer of third party system 160 that requires the use or capabilities of the data privacy system 106 for authorization or verification purposes.

The processing device 502 may be configured to use the communication device 524 to communicate with one or more other devices on a network 101 such as, but not limited to the entity system 180 and the data privacy system 106. In this regard, the communication device 524 may include an antenna 526 operatively coupled to a transmitter 528 and a receiver 530 (together a “transceiver”), modem 532. The processing device 502 may be configured to provide signals to and receive signals from the transmitter 528 and receiver 530, respectively. The signals may include signaling information in accordance with the air interface standard of the applicable BLE standard, cellular system of the wireless telephone network or the like, that may be part of the network 101. In this regard, the user device 104 may be configured to operate with one or more air interface standards, communication protocols, modulation types, and access types. By way of illustration, the user device 104 may be configured to operate in accordance with any of a number of first, second, third, and/or fourth-generation communication protocols or the like. For example, the user device 104 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The user device 104 may also be configured to operate in accordance with non-cellular communication mechanisms, such as via a wireless local area network (WLAN) or other communication/data networks. The user device 104 may also be configured to operate in accordance, audio frequency, ultrasound frequency, or other communication/data networks.

The user device 104 may also include a memory buffer, cache memory or temporary memory device operatively coupled to the processing device 502. Typically, one or more applications, are loaded into the temporarily memory during use. As used herein, memory may include any computer readable medium configured to store data, code, or other information. The memory device 534 may include volatile memory, such as volatile Random Access Memory (RAM) including a cache area for the temporary storage of data. The memory device 534 may also include non-volatile memory, which can be embedded and/or may be removable. The non-volatile memory may additionally or alternatively include an electrically erasable programmable read-only memory (EEPROM), flash memory or the like.

Though not shown in detail, it is understood that the system further includes one or more entity systems 180 which is connected to the user device 104 and the data privacy system 106 and which may be associated with one or more entities, institutions, third party systems 160, or the like. In this way, while only one entity system 180 is illustrated in FIG. 1, it is understood that multiple networked systems may make up the system environment 100. The entity system 180 generally comprises a communication device, a processing device, and a memory device. The entity system 180 comprises computer-readable instructions stored in the memory device, which in one embodiment includes the computer-readable instructions of an entity application. The entity system 180 may communicate with the user device 104 and the data privacy system 106 to provide access to documents stored and maintained on the entity system 180. In some embodiments, the entity system 180 may communicate with the data privacy system 106 during an interaction with a user 102 in real-time, wherein user interactions may be monitored and processed by the data privacy system 106 in order to analyze interactions with the user 102 and reconfigure the machine learning model in response to changes in a received or monitored data stream. In some embodiments, the system is configured to receive data for decisioning, wherein the received data is processed and analyzed by the machine learning model to determine a conclusion.

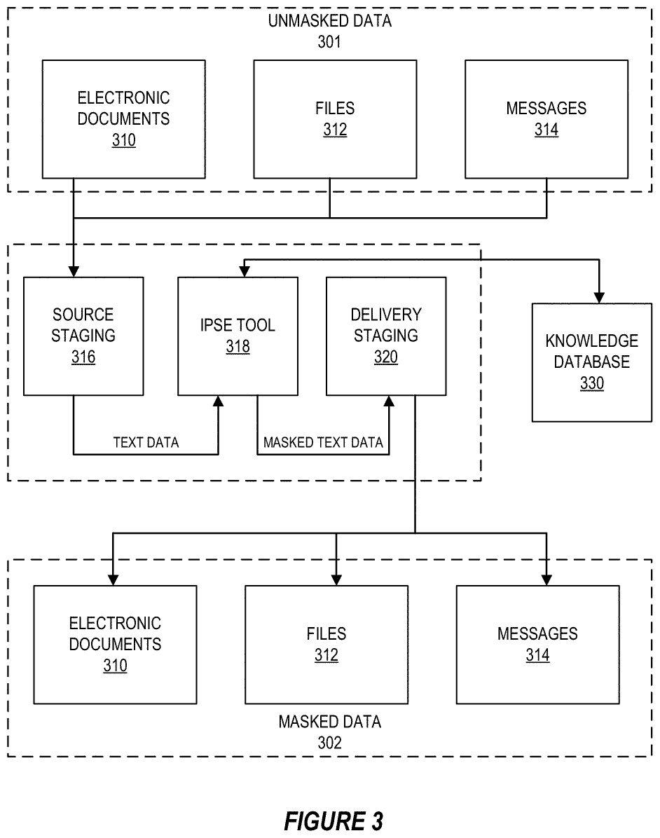

FIG. 3 depicts a high level process flow for the processing of unstructured data, in accordance with embodiments of the present invention. As shown in the embodiment of FIG. 3, the unstructured data may comprise a number of data types, such as electronic documents 310, files 312, and messages 314, or the like. It is understood that while these data types are provided in FIG. 3 for illustrative purposes, the unstructured data may comprise other types of data as well, given that the unstructured data, by definition, is a data that is not organized according to any pre-defined rule set. Unstructured data is typically text-heavy, but may contain data such as dates, numbers, and facts, or the like. In some embodiments, unstructured data may include, but is not limited to, text files, scanned images of documents, payment instruments, contracts, form documents, applications, or the like. As shown, the unstructured data types 310, 312, and 314 all begin as unmasked data 301. In some embodiments, the unmasked data, as received, does not contain any privacy and security enforcement masking implemented by the system (e.g., a contract or completed form document with no redacted or masked portions, or the like).

As shown, the unmasked data is fed, via one or more data channels, to the source staging step 316, wherein the data is preformatted and parsed for processing by the intelligent privacy and security enforcement (IPSE) tool 318. The source staging 316 may include optical character recognition (OCR) of image data to identify textual information, or the like. The text information is exported as text data to the IPSE tool 318, wherein the machine learning and AI engine 146 is utilized, in conjunction with data from the knowledge database 330 in order to identify sensitive data that should be masked. In some embodiments, the AI and machine learning engine 146 is used to analyze received data in order to identify complex patterns and intelligently improve the efficiency and capability of the data privacy system 106 to analyze received data and identify contextual language patterns indicating that the next word may contain a sensitive entity information. In some embodiments, the AI and machine learning engine 146 may include supervised learning techniques, unsupervised learning techniques, or a combination of multiple machine learning models that combine supervised and unsupervised learning techniques. In a preferred embodiment, the AI and machine learning engine 146 of the IPSE tool 318 is unsupervised, such that it may continuously learn and identify new categories of sensitive entity information without user input, examples, or guidance. As such, the unsupervised learning provides a tool for machine learning that searches for previously undetected patterns in an unstructured data set with no pre-existing labels and with a minimal amount of human supervision. In some embodiments, the machine learning engine may include an adversarial neural network that uses a process of encoding and decoding in order to adversarial train one or more machine learning models to identify relevant patterns in received data received from one or more channels of communication. In some embodiments, the IPSE tool 318 may refer to data from the knowledge database 330 in order to guide or verify the identification of sensitive entity information. For instance, if the IPSE tool 318 identifies a contextual rule that a numerical field following the phrase “social security number,” the IPSE tool 318 may refer to the knowledge database 330 in order to confirm that various iterations of “social!”+“securit!” (wherein “!” signifies an advanced operator indicating any number of prefix or suffix possibilities) indicate the presence of nearby sensitive entity information. Given that the data is unstructured text data, the IPSE tool 318 may track “forward” or “backward” from the location of a sensitive entity contextual signal in order to further parse and locate the sensitive entity data. For instance, if a string of unstructured text data contained the phrase “social security number: 000-00-0000,” the IPSE tool may flag “social security number” as a contextual indicator and search before and after the contextual indicator to identify and replace any numerical data with a string of generic characters, or masked data 302, such as black rectangles or other generic masking characters.

The IPSE tool replaced the sensitive data with “masked data” place holders (e.g., textual data is replaced with code language for black rectangles, or the like). The resulting data set, containing masked data in the place of sensitive information, is then sent as masked text data to the delivery staging 320 step. This step may include converting the file type from OCR textual data back into the originating file format (e.g., converting an OCR document containing text fields back into an image-only portable document format (PDF), or the like). The text data extracted from the source staging step 316 is then replaced with the masked text data. In this way, the data types 310, 312, and 314 are output as masked data 302, shown toward the bottom of FIG. 3. As such, the masked data 302 no longer contain any sensitive information, mitigating the potential dangers associated with unauthorized access, leaking, data corruption, or the like.

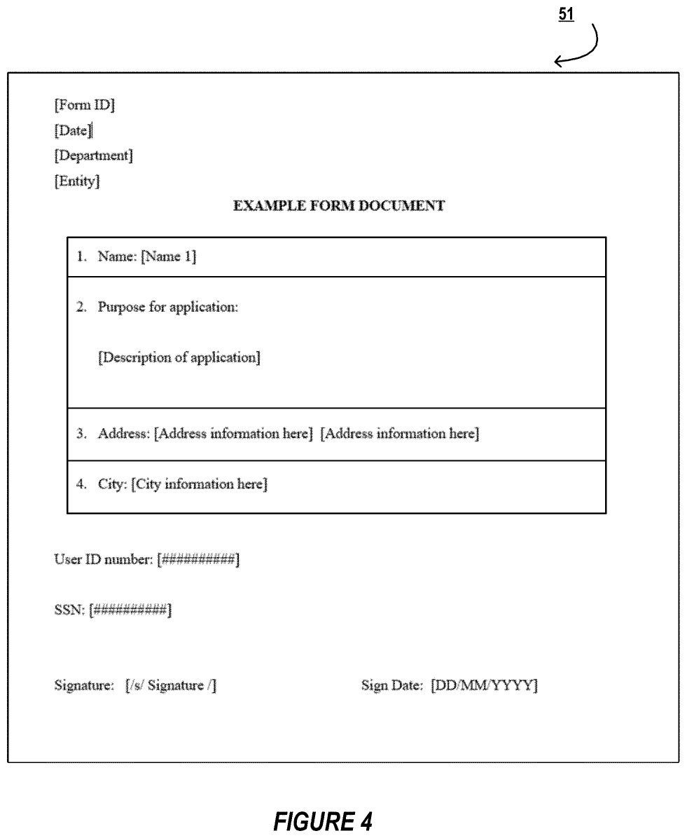

FIG. 4 depicts an example of an unmasked document 51, in accordance with embodiments of the present invention. As shown in the embodiment of FIG. 4, the unmasked document 51 may be some type of form document, application, financial document, filing, or the like that contains personally identifiable or otherwise sensitive information. In other words, the unmasked document 51 may be one of an electronic document 310, file 312, message 314, or the like in the category of unmasked data 301. For instance, the unmasked document 51 may contain fields such as, but not limited to, proprietary form ID, entity information, entity name, user name, user address, geographical area, user ID number, user social security number (SSN), user signature, signature date, or the like. Once extracted as text data, information or data from the unmasked document 51 may be identified by the IPSE tool 318 as sensitive “entity” information, wherein the entity may refer to any subject, user, business, text field, or the like which contains sensitive information or types of unstructured text data that warrants protection from unauthorized viewing, or otherwise represents a problem if disclosed to one or more unauthorized parties.

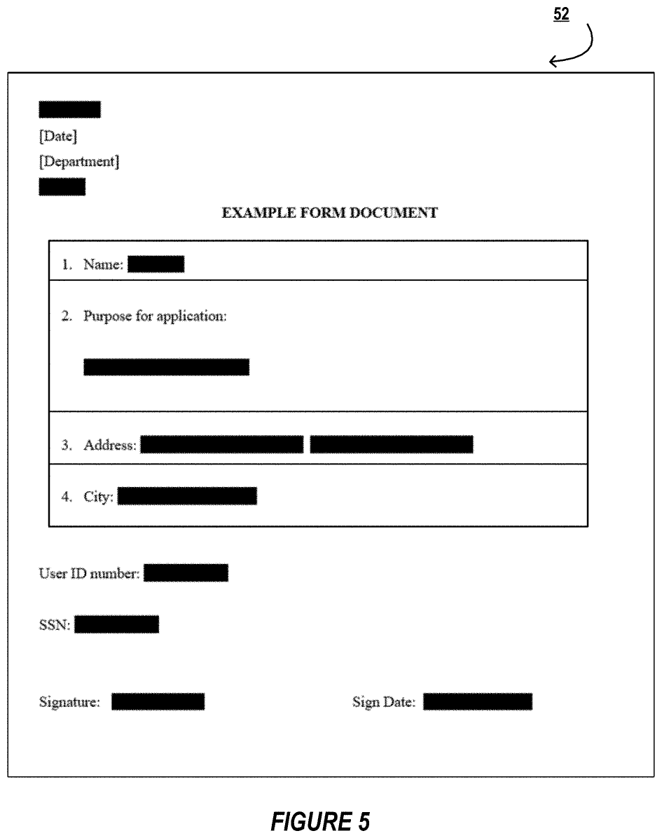

FIG. 5 depicts an example of a masked document 52, in accordance with embodiments of the present invention. As shown in the embodiment of FIG. 4, the masked document 52 may be some type of form document, application, financial document, filing, or the like that contains personally identifiable or otherwise sensitive information that has been redacted or replaced using the present invention. In other words, the masked document 52 may be one of an electronic document 310, file 312, message 314, or the like in the category of masked data 302. As shown, the masked document 52 contains generic black rectangles or redaction characters in place of sensitive entity information identified by the IPSE tool 318. In this way, the masked document 52 can be stored securely. In the event that the masked document is disclosed, shown, accessed, or copied by an unauthorized user, the unauthorized user would not be able to view the sensitive entity information. However, the document may still be accounted for by the entity system 180. In some embodiments, the entity system 180 may access the data privacy system 106 in order to unmask the masked document 52 if need be, but doing so would require further authorization and permission from the separate data privacy system 106, thus adding a layer of security to the storage of unstructured data.

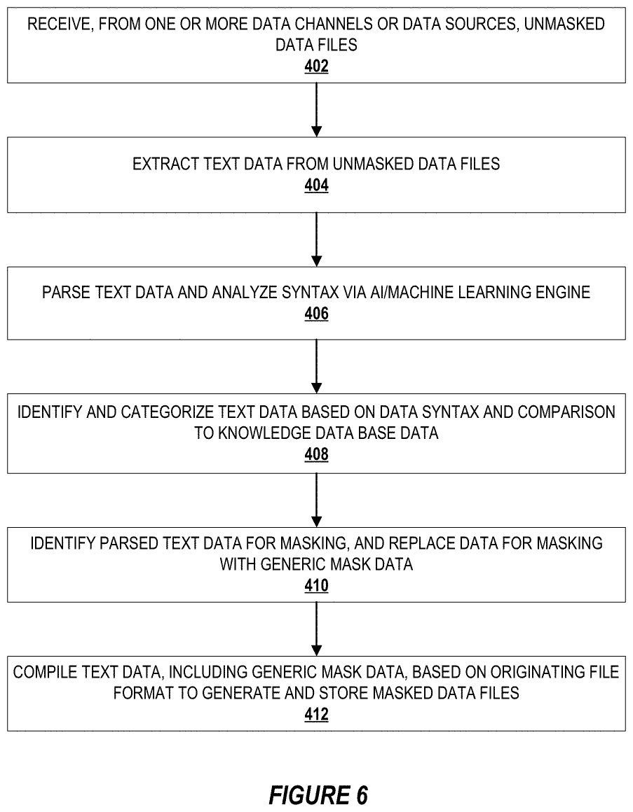

FIG. 6 depicts a high level process flow of intelligent data masking, in accordance with embodiments of the present invention. As shown, the process begins at block 402, wherein the system receives, from one or more data channels or data sources, unmasked data files (e.g., unstructured data of any format type). Next, the system extracts the textual data from the unmasked data files, as shown in block 404. The text data is then parsed and syntax analyzed using the machine learning AI engine 146, as shown in block 406. In some embodiments, the analysis completed using the machine learning AI engine is unsupervised, and may incorporate data from a knowledge database, such as knowledge database 330.

Next, as shown in block 408, the system identifies and categorizes the text data based on the data syntax and identified contextual indicators, and comparison to knowledge database 330 data, as shown in block 408. Sensitive entity data for masking is further identified, as shown in block 410, and the sensitive entity data for masking is replaced with generic mask data. Finally, the system compiles the text data, mask data 302, and reconstructs the data files based on originating file format to generate and store masked data files, as shown in block 412.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, or the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions.

It will also be understood that the one or more computer-executable program code portions may be stored in a transitory or non-transitory computer-readable medium (e.g., a memory, or the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for data analysis and security via intelligent masking of unstructured data, the system comprising:
at least one memory device with computer-readable program code stored thereon;
at least one communication device;
at least one processing device operatively coupled to the at least one memory device and the at least one communication device, wherein executing the computer-readable program code is configured to cause the at least one processing device to:
receive, from one or more data channels and data sources, data files comprising unmasked data;
extract text data from the unmasked data;
parse the text data and analyze syntax of the text data via a machine learning engine;
identify and categorize sensitive text data via the machine learning engine, wherein the sensitive text data is a subset of the text data;
replace the sensitive text data with generic mask data to generate masked text data;
compile the masked text data and reconstruct the data files by substituting the unmasked data with masked data; and
store the data file as a secure masked data file.

2. The system of claim 1, wherein extracting text data from the unmasked data further comprises converting the data files from an originating file type to plain text data.

3. The system of claim 1, wherein the machine learning engine further comprises an unsupervised machine learning model, wherein the unsupervised machine learning model detects sensitive text data based on contextual syntax of the text data.

4. The system of claim 1, wherein the machine learning engine further comprises an unsupervised machine learning model operatively connected to a knowledge database of exemplary sensitive text data types.

5. The system of claim 1, wherein the generic mask data further comprises a black rectangular shape character in place of an alphanumeric character.

6. The system of claim 1, wherein reconstructing the data files further comprises converting plain text data containing masked data to an originating file type of the data files.

7. The system of claim 1, wherein the machine learning engine further comprises an unsupervised machine learning model trained to identify one or more rules for contextual analysis of the text data without human supervision.

8. A computer program product for data analysis and security via intelligent masking of unstructured data, the computer program product comprising a non-transitory computer-readable storage medium having computer-executable instructions to:
receive, from one or more data channels and data sources, data files comprising unmasked data;
extract text data from the unmasked data;
parse the text data and analyze syntax of the text data via a machine learning engine;
identify and categorize sensitive text data via the machine learning engine, wherein the sensitive text data is a subset of the text data;
replace the sensitive text data with generic mask data to generate masked text data;
compile the masked text data and reconstruct the data files by substituting the unmasked data with masked data; and
store the data file as a secure masked data file.

9. The computer program product of claim 8, wherein extracting text data from the unmasked data further comprises converting the data files from an originating file type to plain text data.

10. The computer program product of claim 8, wherein the machine learning engine further comprises an unsupervised machine learning model, wherein the unsupervised machine learning model detects sensitive text data based on contextual syntax of the text data.

11. The computer program product of claim 8, wherein the machine learning engine further comprises an unsupervised machine learning model operatively connected to a knowledge database of exemplary sensitive text data types.

12. The computer program product of claim 8, wherein the generic mask data further comprises a black rectangular shape character in place of an alphanumeric character.

13. The computer program product of claim 8, wherein reconstructing the data files further comprises converting plain text data containing masked data to an originating file type of the data files.

14. The computer program product of claim 8, wherein the machine learning engine further comprises an unsupervised machine learning model trained to identify one or more rules for contextual analysis of the text data without human supervision.

15. A computer implemented method for data analysis and security via intelligent masking of unstructured data, the computer implemented method comprising:
providing a computing system comprising a computer processing device and a non-transitory computer readable medium, where the non-transitory computer readable medium comprises configured computer program instruction code, such that when said instruction code is operated by said computer processing device, said computer processing device performs the following operations:
receive, from one or more data channels and data sources, data files comprising unmasked data;
extract text data from the unmasked data;
parse the text data and analyze syntax of the text data via a machine learning engine;
identify and categorize sensitive text data via the machine learning engine, wherein the sensitive text data is a subset of the text data;
replace the sensitive text data with generic mask data to generate masked text data;
compile the masked text data and reconstruct the data files by substituting the unmasked data with masked data; and
store the data file as a secure masked data file.

16. The computer implemented method of claim 15, wherein extracting text data from the unmasked data further comprises converting the data files from an originating file type to plain text data.

17. The computer implemented method of claim 15, wherein the machine learning engine further comprises an unsupervised machine learning model, wherein the unsupervised machine learning model detects sensitive text data based on contextual syntax of the text data.

18. The computer implemented method of claim 15, wherein the machine learning engine further comprises an unsupervised machine learning model operatively connected to a knowledge database of exemplary sensitive text data types.

19. The computer implemented method of claim 15, wherein the generic mask data further comprises a black rectangular shape character in place of an alphanumeric character.

20. The computer implemented method of claim 15, wherein reconstructing the data files further comprises converting plain text data containing masked data to an originating file type of the data files.
